(19) United States
(12) Patent Application Publication
(10) Pub. No.: US 2024/0371093 A1
(43) Pub. Date: Nov. 7, 2024

(54) POINT CLOUD COMPLETION DEVICE, POINT CLOUD COMPLETION METHOD, AND POINT CLOUD COMPLETION PROGRAM

(71) Applicant: NIPPON TELEGRAPH AND TELEPHONE CORPORATION, Tokyo (JP)

(72) Inventors: Shunsuke TSUKATANI, Tokyo (JP); Shingo ANDO, Tokyo (JP); Jun SHIMAMURA, Tokyo (JP)

(73) Assignee: NIPPON TELEGRAPH AND TELEPHONE CORPORATION, Tokyo (JP)

(21) Appl. No.: 18/689,055

(22) PCT Filed: Sep. 6, 2021
(86) PCT No.: PCT/JP2021/032716

§ 371 Date: Mar. 4, 2024

(51) Int. Cl. G06T 17/00; G06V 10/44; G06V 10/56; G06V 10/60

(52) U.S. Cl. CPC G06T 17/00; G06V 10/44; G06V 10/56; G06V 10/60

(57) ABSTRACT

A point cloud complementing device 100 receives a colored three-dimensional point cloud of each point including a missing region and the number of points to be complemented as inputs. A CPU 11 of the point cloud complementing device 100 extracts a feature vector of the three-dimensional point cloud using a feature extractor learned in advance. The CPU 11 uses a point cloud complementing model learned in advance in consideration of an error between color information and brightness information, has the feature vector and the number of points to be complemented as inputs, and outputs a point cloud obtained by complementing the input three-dimensional point cloud up to the number of points to be complemented by performing correction on point at which the brightness does not change among adjacent points of a predicted point cloud such that the points have close brightness information assuming that the points are on the same plane.

### TECHNICAL FIELD

The disclosed technique relates to a point cloud complementing device, a point cloud complementing method, and a point cloud complementing program.

### BACKGROUND ART

When a three-dimensional map (3D map) is created, actual environment data including a three-dimensional point cloud measured from light detection and ranging (LiDAR) mounted on an automobile or the like is used. In creating a three-dimensional map, a missing region of an object that has not been observed by LiDAR after registration of actual environment data sometimes occurs, and an incomplete three-dimensional map is obtained if nothing is done. As a technique for complementing a missing region of an object with a point cloud, a technique as described in Non Patent Literature 1 has been proposed, but since it only includes complementing the spatial coordinates of the point cloud, it is necessary to complement color information together in a 3D map for which color information is important.

In addition, as a method of adding color information to a point cloud, a technique such as Non Patent Literature 2 has been proposed.

### CITATION LIST

### Non Patent Literature

Non Patent Literature 1: W. Yuan, T. Khot, D. Held, C. Mertz and M. Hebert, “PCN: Point Completion Network,” 2018 International Conference on 3D Vision (3DV), Verona, Italy, 2018, pp. 728-737, doi: 10.1109/3DV.2018.00088.
Non Patent Literature 2: J. Liu, S. Dai and X. Li, “PCCN: POINT Cloud Colorization Network,” 2019 IEEE International Conference on Image Processing (ICIP), Taipei, Taiwan, 2019, pp. 3716-3720, doi: 10.1109/ICIP.2019.8803633.

### SUMMARY OF INVENTION

### Technical Problem

Although teacher data of a target structure is required in order to add color information to a point cloud as in Non Patent Literature 2, learning data for adding color information to a 3D map is a point cloud observed in an actual environment. The point cloud observed in the actual environment is affected by the light source, and when a colored point cloud is complemented for the missing portion of the object, it is necessary to complement the point cloud in accordance with the brightness of the already observed point cloud in creating a high-quality three-dimensional map.

However, since brightness information is not explicitly handled in Non Patent Literature 2, when color information is added to actual environment data, color information having brightness different from that of an already observed point cloud is complemented, and distorted color information is restored for a three-dimensional map.

The disclosed technology has been made in view of the above points, and is designed to correct color information by unifying the brightness of the point cloud of the missing portion having the same normal direction as the point cloud around the missing portion of the object. Thus, it aims to provide a point cloud complementing device, a point cloud complementing method, and a point cloud complementing program that enable restoration of color information of a point cloud in an actual environment that is affected by a light source.

### Solution to Problem

A first aspect of the present disclosure is a point cloud complementing device that receives, as an input, a colored three-dimensional point cloud of each point including a missing region and a number of points to be complemented, and includes a feature extraction unit that extracts a feature vector of the three-dimensional point cloud using a feature extractor learned in advance, and a point cloud complementing unit that uses a point cloud complementary model learned in advance in consideration of an error between color information and brightness information, has the feature vector and the number of points to be complemented as inputs, and outputs a point cloud obtained by complementing the input three-dimensional point cloud up to the number of points to be complemented by performing correction on points at which the brightness does not change among adjacent points of a predicted point cloud such that the points have close brightness information assuming that the points are on the same plane.

A second aspect of the present disclosure is a point cloud complementing method for causing a computer to execute processing of receiving, as an input, a colored three-dimensional point cloud of each point including a missing region and a number of points to be complemented, extracting a feature vector of the three-dimensional point cloud using a feature extractor learned in advance, and using a point cloud complementary model learned in advance in consideration of an error between color information and brightness information, having the feature vector and the number of points to be complemented as inputs, and outputting a point cloud obtained by complementing the input three-dimensional point cloud up to the number of points to be complemented by performing correction on points at which the brightness does not change among adjacent points of a predicted point cloud such that the points have close brightness information assuming that the points are on the same plane.

A third aspect of the present disclosure is a point cloud complementing program for causing a computer to execute processing of receiving, as an input, a colored three-dimensional point cloud of each point including a missing region and a number of points to be complemented, extracting a feature vector of the three-dimensional point cloud using a feature extractor learned in advance, and using a point cloud complementary model learned in advance in consideration of an error between color information and brightness information, having the feature vector and the number of points to be complemented as inputs, and outputting a point cloud obtained by complementing the input three-dimensional point cloud up to the number of points to be complemented by performing correction on points at which the brightness does not change among adjacent points of a predicted point cloud such that the points have close brightness information assuming that the points are on the same plane.

### Advantageous Effects of Invention

According to the disclosed technique, it is possible to restore color information of a point cloud in an actual environment that is affected by a light source.

### BRIEF DESCRIPTION OF DRAWINGS

FIG. 1 is a block diagram illustrating a hardware configuration of a point cloud complementing device.

FIG. 2 is a block diagram illustrating a functional configuration of the point cloud complementing device of the present embodiment.

FIG. 3 is a diagram illustrating an example of a case where an encoder/decoder network is applied to a configuration of a point cloud complementing device.

FIG. 4 is a flowchart showing the flow of a point cloud complementary learning process by the point cloud complementing device.

FIG. 5 is a flowchart showing the flow of a point cloud complementing process by the point cloud complementing device.

### DESCRIPTION OF EMBODIMENTS

Hereinafter, examples of an embodiment of the disclosed technology will be described with reference to the drawings. Further, in the drawings, the same or equivalent components and parts will be denoted by the same reference signs. Furthermore, dimensional ratios in the drawings are exaggerated for convenience of description and thus may be different from actual ratios.

In a method according to an embodiment of the present disclosure, in order to solve the above problems, a point cloud complementary model is learned by using a difference between distance information on a space and distance information on a color space in an error function between a point cloud predicted for a missing portion and a point cloud that is correct, and the point cloud is complemented using the point cloud complementary model at the time of inference. The point cloud complementary model performs learning by performing correction on points at which the brightness does not change among adjacent points of a predicted point cloud such in the normal direction assuming that the points are on the same plane so that the points do not become outliers. By complementing the missing portion of the point cloud using the point cloud complementary model learned in the present technique, the performance of the point cloud complementing is improved.

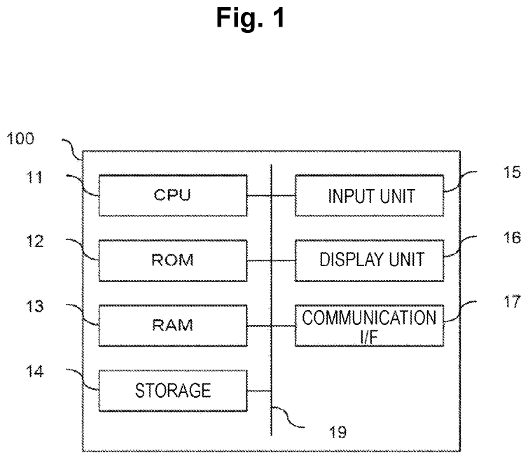

Hereinafter, a configuration of the present embodiment will be described. FIG. 1 is a block diagram illustrating a hardware configuration of a point cloud complementing device 100.

As illustrated in FIG. 1, the point cloud complementing device 100 includes a central processing unit (CPU) 11, a read only memory (ROM) 12, a random access memory (RAM) 13, a storage 14, an input unit 15, a display unit 16, and a communication interface (I/F) 17. The components are communicatively connected to each other via a bus 19.

The CPU 11 is a central processing unit, and executes various programs and controls each unit. That is, the CPU 11 reads the programs from the ROM 12 or the storage 14 and executes the programs by using the RAM 13 as a work area. The CPU 11 controls each configuration described above and performs various types of calculation processes in accordance with the programs stored in the ROM 12 or the storage 14. In the present embodiment, a point cloud complementing program is stored in the ROM 12 or the storage 14.

The ROM 12 stores various programs and various types of data. The RAM 13 serving as a work area temporarily stores programs or data. The storage 14 includes a storage device such as a hard disk drive (HDD) or a solid state drive (SSD) and stores various programs including an operating system and various types of data.

The input unit 15 includes a pointing device such as a mouse and a keyboard and is used to perform various inputs.

The display unit 16 is, for example, a liquid crystal display and displays various types of information. The display unit 16 may function as the input unit 15 by employing a touch panel system.

The communication interface 17 is an interface for communicating with another device such as a terminal. For the communication, for example, a wired communication standard such as Ethernet (registered trademark) or FDDI, or a wireless communication standard such as 4G, 5G, or Wi-Fi (registered trademark) is used.

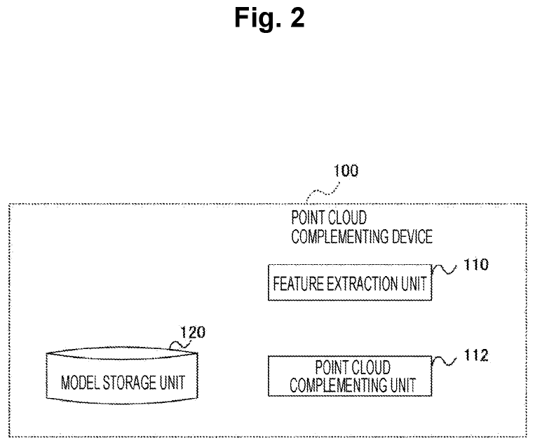

Next, each functional configuration of the point cloud complementing device 100 will be described. FIG. 2 is a block diagram illustrating a functional configuration of the point cloud complementing device according to the present embodiment. Each functional configuration is achieved by the CPU 11 reading the point cloud complementing program stored in the ROM 12 or the storage 14, loading the point cloud complementing program to the RAM 13, and executing the point cloud complementing program.

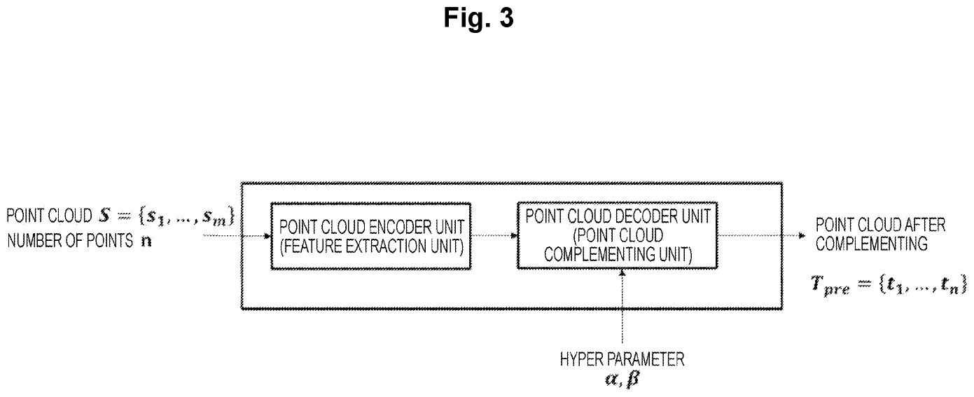

As illustrated in FIG. 2, the point cloud complementing device 100 includes a feature extraction unit 110, a point cloud complementing unit 112, and a model storage unit 120. The point cloud complementing device 100 performs learning and inference in an encoder/decoder network using Non Patent Literature 1 as a base model. FIG. 3 is a diagram illustrating an example of a case where an encoder/decoder network is applied to a configuration of a point cloud complementing device. As illustrated in FIG. 3, the point cloud encoder unit of the encoder/decoder network corresponds to the feature extraction unit 110, and the point cloud decoder unit corresponds to the point cloud complementing unit 112.

The processing of the point cloud complementing device 100 is divided into processing at the time of learning and processing at the time of inference, but can be realized by a similar functional configuration. Hereinafter, each of the time of learning and the time of inference will be described. Further, a device that performs processing at the time of learning and a device that performs processing at the time of inference may be configured separately.

At the time of learning, the point cloud complementing device 100 receives, as inputs, a colored three-dimensional point cloud S of each point (m points) including a missing region and the number of points n to be complemented as learning data. The three-dimensional point cloud S is S={s₁, . . . , sₘ} and sᵢ=[sᵢ^{x}, sᵢ^{y}, sᵢ^{z}, sᵢ^{R}, sᵢ^{G}, sᵢ^{B}]. Similarly at the time of inference, the point cloud complementing device 100 receives the colored three-dimensional point cloud S of each point including the missing portion and the number of points n to be complemented as inputs.

The feature extraction unit 110 uses the three-dimensional point cloud S as an input, and extracts a k-dimensional global feature vector V of the three-dimensional point cloud S. The global feature vector V is calculated using a point cloud feature extractor according to Non Patent Literature 3, but another point cloud feature extractor may be used. The processing at the time of learning and the processing at the time of inference of the feature extraction unit 110 are common.

### Non Patent Literature 3

R. Q. Charles, H. Su, M. Kaichun and L. J. Guibas, “PointNet: Deep Learning on Point Sets for 3D Classification and Segmentation,” 2017 IEEE Conference on Computer Vision and Pattern Recognition (CVPR), 2017, pp. 77-85, doi: 10.1109/CVPR.2017.16.

At the time of learning, the point cloud complementing unit 112 learns the point cloud complementary model to receive the global feature vector V extracted by the feature extraction unit 110 as an input using a loss function considering an error between color information and brightness information and output the RGB colored three-dimensional point cloud Tₚᵣₑ complemented up to n points, and stores the learned point cloud complementary model in the model storage unit 120. At the time of inference, the point cloud complementing unit 112 outputs the RGB colored three-dimensional point cloud Tₚᵣₑ complemented up to n points using a point cloud complementary model learned in advance in consideration of an error between color information and brightness information. The RGB colored three-dimensional point cloud Tₚᵣₑ is Tₚᵣₑ={t₁, . . . , tₙ}, tᵢ=[tᵢ^{x}, tᵢ^{y}, tᵢ^{z}, tᵢ^{R}, tᵢ^{G}, tᵢ^{B}].

The time of learning by the point cloud complementing unit 112 will be described. The point cloud complementing unit 112 learns the point cloud complementary model using a loss function that minimizes a difference between U_{gt} serving as the correct data and Tₚᵣₑ serving as a prediction value. The correct data U_{gt} is U_{gt}={u₁, . . . , uₙ} and uᵢ=[uᵢ^{x}, uᵢ^{y}, uᵢ^{z}, uᵢ^{R}, uᵢ^{G}, uᵢ^{B}]. The point cloud complementary model performs learning using the loss function L (Tₚᵣₑ, U_{gt}) of the following expression (1).

$$\begin{matrix}[ Math . 1 ] & \\ L ( {T}_{pre} , {U}_{gt} ) = d ( {T}_{pre} , {U}_{gt} ) + α {d}_{c} ( {T}_{pre} , {U}_{gt} ) + β V ( {T}_{pre} ) & ( 1 )\end{matrix}$$

(1) In the loss function of the expression, error functions (first to third error functions) shown in the following expressions (1-1) to (1-3) are used.

$$\begin{matrix}[ Math . 2 ] & \\ d ( {T}_{pre} , {U}_{gt} ) = \frac{1}{\vert {T}_{pre} \vert} {\sum }_{{t}_{i} ∈ {T}_{pre}} {min}_{{u}_{i} ∈ {T}_{pre}} {‖ {t}_{i} - {u}_{i} ‖}_{2} + \frac{1}{\vert {U}_{gt} \vert} {\sum }_{{u}_{i} ∈ {U}_{gt}} {min}_{{u}_{i} ∈ {U}_{gt}} {‖ {u}_{i} - {t}_{i} ‖}_{2} & ( 1 - 1 )\end{matrix}$$

$$\begin{matrix}[ Math . 3 ] & \\ {d}_{c} ( {T}_{pre} , {U}_{gt} ) = {\sum }_{{t}_{i} = {argmin}_{{t}_{i} ∈ {T}_{pre} , {u}_{i} ∈ {U}_{gt}} {‖ {u}_{i} - {t}_{i} ‖}_{2}} \sqrt{{( {t}_{i}^{R} - {u}_{i}^{R} )}^{2} + {( {t}_{i}^{G} - {u}_{i}^{G} )}^{2} + {( {t}_{i}^{B} - {u}_{i}^{B} )}^{2}} & ( 1 - 2 )\end{matrix}$$

$$\begin{matrix}[ Math . 4 ] & \\ V ( {T}_{pre} ) = {\sum }_{{t}_{i} = {argmin}_{{t}_{i} , {t}_{j} ∈ {T}_{pre}} {‖ {t}_{i} - {t}_{j} ‖}_{2}} exp ( - {Δ ( {t}_{i}^{V} - {t}_{j}^{V} )}^{2} ) {‖ {n}_{{t}_{i}} - {n}_{{t}_{j}} ‖}^{2} & ( 1 - 3 )\end{matrix}$$

Here, α and β represent hyperparameters, tᵢ^{V} represents brightness information after t: is converted from RGB to HSV, and nₜᵢ (i is a subscript of t, and the same applies to nₜᵢ and nₜⱼ below) represents a normal vector of ti.

d(Tₚᵣₑ, U_{gt}) is an example of a first error function for obtaining an error of the spatial distance between Tₚᵣₑ and U_{gt} using the Chamfer Distance. d_{c}(Tₚᵣₑ, U_{gt}) is an example of a second error function for obtaining an error of a color spatial distance by RGB color information for the nearest neighbor point between Tₚᵣₑ and U_{gt}. For RGB, errors of tᵢ^{R} and uᵢ^{R}, tᵢ^{G} and uᵢ^{G}, tᵢ^{B} and uᵢ^{B} are obtained. V(Tₚᵣₑ) is an example of a third error function that performs learning in which, after meshing is performed on Tₚᵣₑ, points having close brightness at the point near ti are assumed to belong to the same plane, and in a case where the brightness is close, the normal nₜᵢ is close to the normal nₜⱼ of the near point. The point cloud complementing unit 112 learns the point cloud complementary model by the loss function L (Tₚᵣₑ, U_{gt}) considering the error between the color information and the brightness information as described above.

At the time of inference, the point cloud complementing unit 112 uses the point cloud complementing model stored in the model storage unit 120 and uses the global feature vector V and the number of points n to be complemented as inputs to infer the complemented point cloud. In the inference of the point cloud complementing unit 112, by performing correction on points at which the brightness does not change among adjacent points of a predicted point cloud such that the points have close brightness information assuming that the points are on the same plane, the point cloud Tₚᵣₑ is output in which the input three-dimensional point cloud S is complemented to the number of points n to be complemented.

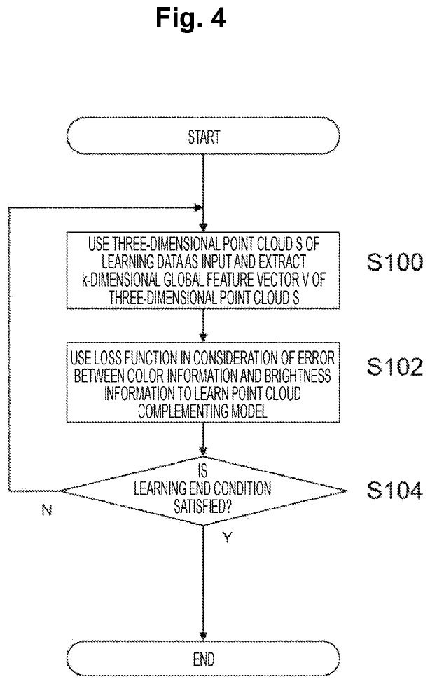

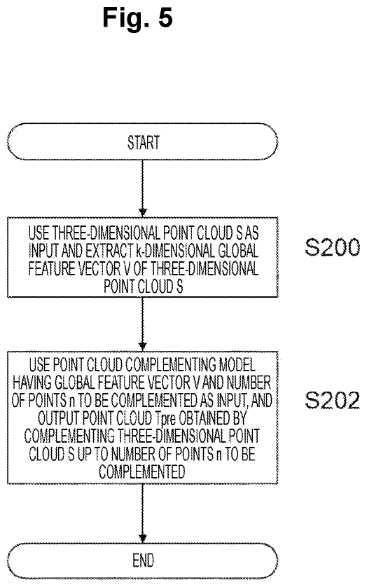

Next, effects of the point cloud complementing device 100 will be described. The effects of a point cloud complementary learning process as a learning process and a point cloud complementary process as the inference process will be described. FIG. 4 is a flowchart showing the flow of a point cloud complementary learning process by the point cloud complementing device 100. FIG. 5 is a flowchart showing the flow of a point cloud complementing process by the point cloud complementing device 100. The point cloud complementing learning process or point cloud complementing process is performed by the CPU 11 reading a point cloud complementing program from the ROM 12 or the storage 14, loading the program in the RAM 13, and executing the program. Further, the point cloud complementing learning process is performed in advance before the point cloud complementing processing is performed, and the learned point cloud complementary model is stored in the model storage unit 120.

The point cloud complementing learning process of FIG. 4 will be described. In the point cloud complementing learning process, learning is performed using each of a plurality of pieces of prepared learning data (colored three-dimensional point cloud S of each point (m points) including a missing region and the number of points n to be complemented). Learning data to be used for learning is selected at the beginning of the point cloud complementing learning process.

In step S100, the CPU 11 causes the feature extraction unit 110 to use the three-dimensional point cloud S of the learning data as an input to extract a k-dimensional global feature vector V of the three-dimensional point cloud S.

In step S102, the CPU 11 causes the point cloud complementing unit 112 to learns the point cloud complementary model by using the global feature vector V extracted by the feature extraction unit 110 and the number of points n to be complemented using the loss function considering an error between color information and brightness information. The loss function of the above expression (1) is used in learning of the point cloud complementing model. The learning is performed such that the loss function minimizes a difference between U_{gt} serving as the correct data and Tₚᵣₑ serving as a prediction value. Tₚᵣₑ, which is a prediction value, is a point cloud obtained by complementing the three-dimensional point cloud S input using the point cloud complementing model in the learning stage to the number of points n to be complemented.

In step S104, the CPU 11 causes the point cloud complementing unit 112 to determine whether the learning end condition is satisfied. The learning end condition may be, for example, the end of learning after using all of the learning data, the number of repetitions, or the like. If it is determined that the learning end condition is satisfied, the point cloud complementing model learned in step S106 is stored in the model storage unit 120, and the process is ended. If it is determined that the learning end condition is not satisfied, the process returns to step S100, the next learning data is selected and the process is repeated.

The point cloud complementing learning process of FIG. 5 will be described.

In step S200, the CPU 11 causes the feature extraction unit 110 to use the three-dimensional point cloud S as an input to extract a k-dimensional global feature vector V of the three-dimensional point cloud S.

In step S202, the CPU 11 causes the point cloud complementing unit 112 to use the global feature vector V and the number of points n to be complemented as inputs using the point cloud complementing model stored in the model storage unit 120, and outputs the point cloud Tₚᵣₑ obtained by complementing the input three-dimensional point cloud S to the number of points n to be complemented. In this inference, points at which the brightness does not change among adjacent points of the predicted point cloud are corrected such that the points have close brightness information assuming that the points are on the same plane.

According to the point cloud complementing device 100 of the present embodiment described above, it is possible to restore color information of a point cloud in an actual environment affected by a light source.

Further, the point cloud complementing process executed by the CPU reading software (program) according to the above embodiment may be executed by any of various processors other than the CPU. Examples of the processors in this case include a programmable logic device (PLD) of which a circuit configuration can be changed after manufacturing such as a field-programmable gate array (FPGA) or the like, and a dedicated electric circuit that is a processor having a circuit configuration exclusively designed for executing a specific process, such as an application specific integrated circuit (ASIC). In addition, the point cloud complementing process may be executed by one of these various processors or may be executed by a combination of the same processors or two or more different types of processors (for example, a plurality of FPGAs, a combination of a CPU and an FPGA, or the like). In addition, more specifically, a hardware structure of the various processors is an electric circuit in which circuit elements such as semiconductor elements are combined.

In addition, an aspect in which the point cloud complementing program is stored (installed) in advance in the storage 14 has been described in the above embodiment, the present invention is not limited thereto. The program may be provided in the form of a program stored in a non-transitory storage medium such as a compact disk read only memory (CD-ROM), a digital versatile disk read only memory (DVD-ROM), or a universal serial bus (USB) memory. In addition, the program may be downloaded from an external device via a network.

Regarding the above embodiment, the following supplementary notes are further disclosed.

### (Supplementary Note 1)

A point cloud complementing device including
a memory; and
at least one processor connected to the memory, in which
the processor
receives, as an input, a colored three-dimensional point cloud of each point including a missing region and the number of points to be complemented;
extracts a feature vector of the three-dimensional point cloud using a feature extractor learned in advance; and
uses a point cloud complementing model learned in advance in consideration of an error between color information and brightness information, having the feature vector and the number of points to be complemented as inputs, performs correction on points at which the brightness does not change among adjacent points of a predicted point cloud such that the points have close brightness information assuming that the points are on the same plane, and thereby outputs a point cloud by complementing the input three-dimensional point cloud up to the number of points to be complemented.

### (Supplementary Note 2)

A non-transitory storage medium storing a program executable by a computer to execute a point cloud complementing process, the non-transitory storage medium
receives, as an input, a colored three-dimensional point cloud of each point including a missing region and the number of points to be complemented;
extracts a feature vector of the three-dimensional point cloud using a feature extractor learned in advance; and
uses a point cloud complementing model learned in advance in consideration of an error between color information and brightness information, having the feature vector and the number of points to be complemented as inputs, performs correction on points at which brightness does not change among adjacent points of a predicted point cloud such that the points have close brightness information assuming that the points are on the same plane, and thereby outputs a point cloud by complementing the input three-dimensional point cloud up to the number of points to be complemented.

### REFERENCE SIGNS LIST

100 Point cloud complementing device
110 Feature extraction unit
112 Point cloud complementing unit
120 Model storage unit

1. A point cloud complementing device comprising a processor configured to execute operations comprising:
receiving, as an input, a colored three-dimensional point cloud of each point including a missing region and a number of points to be complemented;
extracting a feature vector of the colored three-dimensional point cloud using a feature extractor learned in advance; and
generating, by a point cloud complementing model learned in advance in consideration of an error between color information and brightness information, based on the feature vector and the number of points to be complemented as inputs, a point cloud by complementing the input three-dimensional point cloud up to the number of points to be complemented by performing correction on points at which the brightness does not change among adjacent points of a predicted point cloud such that the points have close brightness information assuming that the points are on the same plane.

2. The point cloud complementing device according to claim 1, wherein
the point cloud complementing model is learned to determine the error between color information and brightness information by using:
a first error function for obtaining a first error in a spatial distance between a predicted value of a colored three-dimensional point cloud and correct data,
a second error function for obtaining a second error in a color spatial distance of color information for a nearest point, and
a third error function for assuming that points having close brightness among neighboring points belong to the same plane and making a normal close to a neighboring point when brightness is close in a loss function.

3. A point cloud complementing method comprising:
receiving, as an input, a colored three-dimensional point cloud of each point including a missing region and a number of points to be complemented;
extracting a feature vector of the colored three-dimensional point cloud using a feature extractor learned in advance; and
generating, by a point cloud complementing model learned in advance in consideration of an error between color information and brightness information, based on the feature vector and the number of points to be complemented as inputs, a point cloud obtained by complementing the input three-dimensional point cloud up to the number of points to be complemented by performing correction on points at which brightness does not change among adjacent points of a predicted point cloud such that the points have close brightness information assuming that the points are on the same plane.

4. A computer-readable non-transitory recording medium storing a computer-executable point cloud complementing program instructions that when executed by a processor cause a computer to execute operations comprising:
receiving, as an input, a colored three-dimensional point cloud of each point including a missing region and a number of points to be complemented;
extracting a feature vector of the colored three-dimensional point cloud using a feature extractor learned in advance; and
generating, by a point cloud complementing model learned in advance in consideration of an error between color information and brightness information, based on the feature vector and the number of points to be complemented as inputs, a point cloud by complementing the input three-dimensional point cloud up to the number of points to be complemented by performing correction on points at which the brightness does not change among adjacent points of a predicted point cloud such that the points have close brightness information assuming that the points are on the same plane.

5. The point cloud complementing device according to claim 1, the processor further configured to execute operations comprising:
learning the point cloud complementing model, based on assuming points at which the brightness does not change among adjacent points of the predicted point cloud as being on a plane, correcting the points toward a normal direction to prevent the points from becoming outliers.

6. The point cloud complementing device according to claim 1, wherein the colored three-dimensional point cloud represents a three-dimensional color map of an area.

7. The point cloud complementing device according to claim 1, wherein the point cloud complementing model includes an encoder-decoder network.

8. The point cloud complementing method according to claim 3, wherein
the point cloud complementing model is learned to determine the error between color information and brightness information by using:
a first error function for obtaining a first error in a spatial distance between a predicted value of a colored three-dimensional point cloud and correct data,
a second error function for obtaining a second error in a color spatial distance of color information for a nearest point, and
a third error function for assuming that points having a brightness within a predetermined threshold among neighboring points belong to the same plane and making a normal close to a neighboring point when brightness is close in a loss function.

9. The point cloud complementing method according to claim 3, further comprising:
learning the point cloud complementing model, based on assuming points at which the brightness does not change among adjacent points of the predicted point cloud as being on a plane, correcting the points toward a normal direction to prevent the points from becoming outliers.

10. The point cloud complementing method according to claim 3, wherein the colored three-dimensional point cloud represents a three-dimensional color map of an area.

11. The point cloud complementing method according to claim 3, wherein the point cloud complementing model includes an encoder-decoder network.

12. The computer-executable non-transitory recording medium according to claim 4, wherein
the point cloud complementing model is learned to determine the error between color information and brightness information by using:
a first error function for obtaining a first error in a spatial distance between a predicted value of a colored three-dimensional point cloud and correct data,
a second error function for obtaining a second error in a color spatial distance of color information for a nearest point, and
a third error function for assuming that points having a brightness within a predetermined threshold among neighboring points belong to the same plane and making a normal close to a neighboring point when brightness is close in a loss function.

13. The computer-executable non-transitory recording medium according to claim 4, the computer-executable point cloud complementing program instructions when executed further causing the computer to execute operations comprising:
learning the point cloud complementing model, based on assuming points at which the brightness does not change among adjacent points of the predicted point cloud as being on a plane, correcting the points toward a normal direction to prevent the points from becoming outliers.

14. The computer-executable non-transitory recording medium according to claim 4, wherein the colored three-dimensional point cloud represents a three-dimensional color map of an area.

15. The computer-executable non-transitory recording medium according to claim 4, wherein the point cloud complementing model includes an encoder-decoder network.
